(19) United States
(12) Patent Application Publication
(10) Pub. No.: US 2015/0140455 A1
(43) Pub. Date: May 21, 2015

(54) IRON-AIR ASSEMBLED CELL AND METHOD FOR USING THE SAME

(71) Applicant: TOYOTA JIDOSHA KABUSHIKI KAISHA, Toyota-shi (JP)

(72) Inventor: Manabu Imano, Hadano-shi (JP)

(21) Appl. No.: 14/546,395

(22) Filed: Nov. 18, 2014

(30) Foreign Application Priority Data
Nov. 19, 2013 (JP) 2013-239281

(51) Int. Cl. H01M 12/08

(52) U.S. Cl. CPC H01M 12/08; H01M 2220/30
USPC 429/405

(57) ABSTRACT

Disclosed is a method for using an iron-air assembled cell, wherein, when iron (Fe) contained in a first anode is turned into an iron compound A and, as a result, the voltage of a first iron-air unit cell becomes less than 0.7 V, a second anode is changed to a third anode comprising a third anode active material that contains iron (Fe) as a major component, or a second iron-air unit cell is changed to a third iron-air unit cell which comprises at least a third cathode, the third anode, and a third electrolyte layer present between the third cathode and anode, and which has a voltage of 0.7 V or more and 1 V or less.

### TECHNICAL FIELD

The present invention relates to an iron-air assembled cell which is configured to be able to supply a stable potential. Also, the present invention relates to a method for using the cell.

### BACKGROUND ART

It is known that various kinds of metal active materials are used in the anode of an air cell. A battery system is disclosed in Patent Literature 1, which uses air as a cathode active material and a specific substance as an anode active material, and which includes a thin magnesium film; a pair of reels with ends connected with the thin magnesium film; and an electrode arranged in the vicinity of a passage of the thin film between the reels.

### CITATION LIST

Patent Literature 1: Japanese Patent Application Laid-Open No. 2012-015013

### SUMMARY OF INVENTION

### Technical Problem

In Patent Literature 1, there is a suggestion of an air cell using a thin iron film, in addition to an air cell using a thin magnesium film. However, in a study done by the inventor of the present invention, it has been found that an air unit cell using iron in the anode, cause a problem of unstable potential when the cell is used alone.

The present invention was achieved in light of such a circumstance that an iron-air unit cell cannot keep a constant potential when it is used alone. An object of the present invention is to provide an iron-air assembled cell which is configured to be able to supply a stable potential, and also to provide a method for using the cell.

### Solution to Problem

The method for using an iron-air assembled cell according to the present invention is a method for using an iron-air assembled cell, the assembled cell comprising: a first iron-air unit cell which comprises at least a first cathode, a first anode comprising a first anode active material that contains iron (Fe) as a major component, and a first electrolyte layer present between the first cathode and anode, and which has a voltage of 0.7 V or more and 1 V or less; and a second iron-air unit cell which comprises at least a second cathode, a second anode comprising a second anode active material that contains an iron compound A as a major component, and a second electrolyte layer present between the second cathode and anode, which has a voltage of 0.4 V or more and less than 0.7 V, and which is connected to the first iron-air unit cell in series, wherein, when the iron (Fe) contained in the first anode is turned into an iron compound A and, as a result, the voltage of the first iron-air unit cell becomes less than 0.7 V, the second anode is changed to a third anode comprising a third anode active material that contains iron (Fe) as a major component, or the second iron-air unit cell is changed to a third iron-air unit cell which comprises at least a third cathode, the third anode, and a third electrolyte layer present between the third cathode and anode, and which has a voltage of 0.7 V or more and 1 V or less.

The iron-air assembled cell of the present invention comprises: a first iron-air unit cell which comprises at least a first cathode, a first anode comprising a first anode active material that contains iron (Fe) as a major component, and a first electrolyte layer present between the first cathode and anode, and which has a voltage of 0.7 V or more and 1 V or less; and a second iron-air unit cell which comprises at least a second cathode, a second anode comprising a second anode active material that contains an iron compound A as a major component, and a second electrolyte layer present between the second cathode and anode, which has a voltage of 0.4 V or more and less than 0.7 V, and which is connected to the first iron-air unit cell in series.

In the assembled cell and the method for using the same of the present invention, preferably, the first iron-air unit cell comprises: a first thin film which contains the first anode active material that contains iron as a major component; a pair of first and second reels to which ends of both extended sides of the first thin film are connected; a first cell case for housing the first thin film and the pair of the first and second reels; the first electrolyte layer arranged in the vicinity of at least part of a path of the first thin film; and the first cathode facing the first thin film through the first electrolyte layer, and the second iron-air unit cell comprises: a second thin film which contains the second anode active material that contains the iron compound A as a major component; a pair of third and fourth reels to which ends of both extended sides of the second thin film are connected; a second cell case for housing the second thin film and the pair of the third and fourth reels; the second electrolyte layer arranged in the vicinity of at least part of a path of the second thin film; and the second cathode facing the second thin film through the second electrolyte layer.

In the assembled cell and the method for using the same of the present invention, preferably, the iron contained in the first anode active material accounts for 50% by mass or more of the first anode active material.

In the assembled cell and the method for using the same of the present invention, preferably, the iron compound A contained in the second anode active material accounts for 50% by mass or more of the second anode active material.

### Advantageous Effects of Invention

According to the present invention, the potential of an iron-air assembled cell can be consistently kept constant, and the supply of a stable potential, which has been difficult for conventional iron-air cells, can be achieved by connecting at least two types of iron-air unit cells having different voltages in series and by exchanging the second iron-air unit cell with a lower voltage or the anode thereof for a third iron-air unit cell with a higher voltage or a third anode when the first iron-air unit cell shows a decrease in voltage.

### BRIEF DESCRIPTION OF DRAWINGS

FIG. 1 is a schematic sectional view of a first embodiment of the iron-air assembled cell according to the present invention.

FIG. 2 is a schematic sectional view of a second iron-air unit cell that constitutes the first embodiment, with its second cathode and second electrolyte layer being removed therefrom.

FIG. 3 is a view showing schematically a side face and a top face of a car including the first embodiment of the iron-air assembled cell according to the present invention.

FIG. 4 is a schematic perspective view of a second embodiment of the iron-air assembled cell according to the present invention.

FIG. 5 is a schematic perspective view of a second iron-air unit cell that constitutes the second embodiment, with its second cathode removed therefrom.

FIG. 6 is a schematic perspective view of a third embodiment of the iron-air assembled cell according to the present invention.

FIG. 7 is a schematic perspective view of a second iron-air unit cell that constitutes the third embodiment, with its cathode removed therefrom.

FIG. 8 is a schematic perspective view of a fourth embodiment of the iron-air assembled cell according to the present invention.

FIG. 9 is a schematic perspective view of a second iron-air unit cell that constitutes the fourth embodiment, with its cathode removed therefrom.

FIG. 10 is a flow chart of a first embodiment of the method for using the iron-air assembled cell according to the present invention.

FIG. 11 is a flow chart of a second embodiment of the method for using the iron-air assembled cell according to the present invention.

FIG. 12 is a graph showing a change in iron-air unit cell voltage over time.

### DESCRIPTION OF EMBODIMENTS

In the present invention, for the sake of convenience, the iron-air assembled cell will be described first, followed by the method for using the iron-air assembled cell.

### 1. Iron-Air Assembled Cell

The iron-air assembled cell of the present invention comprises: a first iron-air unit cell which comprises at least a first cathode, a first anode comprising a first anode active material that contains iron (Fe) as a major component, and a first electrolyte layer present between the first cathode and anode, and which has a voltage of 0.7 V or more and 1 V or less; and a second iron-air unit cell which comprises at least a second cathode, a second anode comprising a second anode active material that contains an iron compound A as a major component, and a second electrolyte layer present between the second cathode and anode, which has a voltage of 0.4 V or more and less than 0.7 V, and which is connected to the first iron-air unit cell in series.

In the present invention, the first and second iron-air unit cells are cells with different types of anode active materials and different voltages. In particular, in the first iron-air unit cell, the anode active material contains iron (Fe) as a major component, and the unit cell has a voltage of 0.7 V or more and 1 V or less. In the second iron-air unit cell, the anode active material contains the iron compound A as a major component, and the unit cell has a voltage of 0.4 V or more and less than 0.7 V.

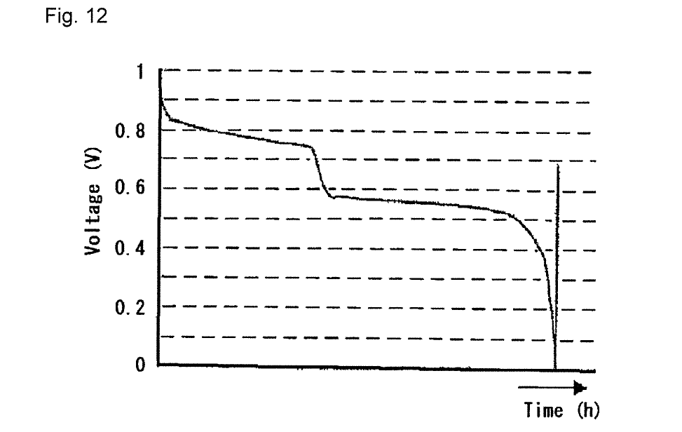

FIG. 12 is a graph showing a change in iron-air unit cell voltage over time. Also, FIG. 12 is a graph with cell voltage (V) on the vertical axis and hour (h) on the horizontal axis.

As is clear from FIG. 12, the iron-air unit cell in use has a time at which the voltage is kept at 0.7 V or more and 1 V or less and a time at which the voltage becomes 0.4 V or more and 0.6 V or less. At the time at which the voltage is kept at 0.7 V or more and 1 V or less, it is thought that at least one of the electrode reactions represented by the following formulae (1a) and (1b) mainly proceeds in the anode of the iron-air unit cell.

Fe+2OH⁻→Fe(OH)₂+2e⁻ Formula (1a):

4Fe(OH)₂+O₂→4FeO(OH)+2H₂O Formula (1b):

At the time at which the voltage becomes 0.4 V or more and 0.6 V or less, it is thought that at least one of the electrode reactions represented by the following formulae (2a) and (2b) mainly proceeds in the anode of the iron-air unit cell.

Fe(OH)₂+OH⁻→FeO(OH)+H₂O+e⁻ Formula (2a):

3Fe(OH)₂+2OH⁻→Fe₃O₄+4H₂O+2e⁻ Formula (2b ):

As just described, the iron-air unit cell shows two different voltages, depending on operating time. In the present invention, a constant voltage can be consistently obtained by connecting the first iron-air unit cell having a voltage of 0.7 V or more and 1 V or less in series to the second iron-air unit cell having a voltage of 0.4 V or more and 0.6 V or less. However, as shown in FIG. 12, the voltage of the first iron-air unit cell become less than 0.7 V with operating time. The method for using the unit cell in this case will be described below in detail.

The electrode reaction formulae (1a), (1b), (2a) and (2b) are merely examples of electrode reactions in the anode of the first or second iron-air unit cell. Therefore, the first or second iron-air unit cell is not limited to one in which the electrode reactions represented by the formulae (1a), (1b), (2a) and (2b) proceed.

Also, the first and second iron-air unit cells of the present invention can have the same structure or different structures, besides having different types of anode active materials and different cell voltages.

Many iron-making techniques, especially techniques for returning oxidized iron to metal iron, have been known.

There are many techniques for removing the anode (oxidized iron) from the iron-air assembled cell of the present invention after use and then generating metal iron. Therefore, from the viewpoint of being able to regenerate the used anode, the iron-air cell is advantageous in that it can be produced at a lower cost, than the case of using other types of metal-air cells.

Also, while the oxidation reaction of the anode in the iron-air cell is at least a two-electron reaction, the oxidation reaction of the anode in well-known conventional metal-air cells, especially lithium-air cells and sodium-air cells, is a one-electron reaction. That is, in the iron-air cell, the number of electrons that participate in the oxidation reaction of the anode is larger than conventional metal-air cells, so that the iron-air cell has a higher capacity.

Hereinafter, the first iron-air unit cell of the present invention will be described in detail.

The first iron-air unit cell includes at least the first cathode, the first anode and the first electrolyte layer.

The first cathode used in the present invention preferably includes a cathode layer. In general, it further includes a cathode current collector and a cathode lead connected to the cathode current collector.

The cathode layer used in the present invention contains at least an electroconductive material. As needed, it can further contain at least one of a catalyst and a binder.

The electroconductive material used in the present invention is not particularly limited, as long as it is electroconductive. The examples include a carbonaceous material, a perovskite-type electroconductive material, a porous electroconductive polymer and a porous metal material. Especially, the carbonaceous material can be porous or non-porous. However, in the present invention, the carbonaceous material is preferably porous, because a large specific surface area and many reaction sites can be offered. Concrete examples of porous carbonaceous materials include mesoporous carbon. Concrete examples of non-porous carbonaceous materials include graphite, acetylene black, carbon black, carbon nanotubes and carbon fibers. The content of the electroconductive material in the cathode layer accounts for preferably 10 to 99% by mass of the cathode layer, particularly preferably 50 to 95% by mass of the cathode layer. This is because there is a possible decrease in reaction sites and cell capacity when the content of the electroconductive material is too small. When the content is too large, there is a possible relative decrease in catalyst content and may result in poor catalyst performance.

As a cathode catalyst used in the present invention, for example, there may be mentioned an oxygen-activating catalyst. The examples include platinum group metals such as nickel, palladium and platinum; perovskite-type oxides containing a transition metal such as cobalt, manganese or iron; inorganic compounds containing a noble metal oxide such as ruthenium, iridium or palladium; metal-coordinated organic compounds having a porphyrin or phthalocyanine structure; and manganese oxide. The content ratio of the catalyst in the cathode layer is not particularly limited. However, the content ratio accounts for preferably 0 to 90% by mass of the cathode layer, particularly preferably 1 to 90% by mass of the cathode layer.

From the viewpoint of smooth electrode reaction, the catalyst can be supported by the electroconductive material.

The cathode layer is needed to contain at least the electroconductive material. However, it is more preferable that the cathode layer further contains a binder for fixing the electroconductive material. Examples of binders include rubber resins such as polyvinylidene fluoride (PVdF), polytetrafluoroethylene (PTFE) and styrene-butadiene rubber (SBR). The content ratio of the binder in the cathode layer is not particularly limited. However, the content ratio accounts for preferably 1 to 40% by mass of the cathode layer, particularly preferably 1 to 10% by mass of the cathode layer.

Methods for producing the cathode layer include, but not limited to, the following method, for example: a method in which materials for the cathode layer, including the electroconductive material, are mixed and roll-pressed; and a method in which a slurry is prepared by mixing a solvent with materials for the cathode layer, including the electroconductive material, and then applied to the below-described cathode current collector. Methods for applying the slurry to the cathode current collector include known methods such as a spraying method, a screen printing method, a doctor blade method, a gravure printing method and a die coating method.

The thickness of the cathode layer varies depending on the application of the air cell, etc. For example, the thickness is preferably 2 to 500 μm, particularly preferably 30 to 300 μm.

The cathode current collector used in the present invention collects current from the cathode layer. The material for the cathode current collector is not particularly limited, as long as it is electroconductive. However, the examples include stainless-steel, nickel, aluminum, iron, titanium and carbon. As the form of the cathode current collector, there may be mentioned a foil form, a plate form and a mesh (grid) form, for example. From the viewpoint of excellent current-collecting efficiency, the cathode current collector preferably has a mesh form. In this case, generally, the cathode current collector in a mesh form is provided inside the cathode layer. In addition, the iron-air assembled cell of the present invention can further include a different cathode current collector (such as a current collector in a foil form) for collection of charge collected by the cathode current collector in a mesh form. In the present invention, the below-described cell case can also function as the cathode current collector.

The thickness of the cathode current collector is, for example, 10 to 1,000 μm, particularly preferably 20 to 400 μm.

The first anode used in the present invention preferably includes a first anode active material layer containing the first anode active material. In general, it further includes a first anode current collector and an anode lead connected to the first anode current collector.

The first anode used in the present invention contains the first anode active material that contains iron (Fe) as a major component. As used herein, “contains iron (Fe) as a major component” means that among the amounts of the components contained in the anode active material, the amount of iron is the highest.

Preferably, the iron contained in the first anode active material accounts for 50% by mass or more of the first anode active material. By containing such a large amount of iron, the anode reaction represented by the formula (1a) proceeds in the anode of the first iron-air unit cell; therefore, the first iron-air unit cell has a voltage of 0.7 V or more and 1 V or less.

It is more preferable that the iron contained in the first anode active material accounts for 70% by mass or more of the first anode active material. It is still more preferable that the iron contained in the first anode active material accounts for 90% by mass or more of the first anode active material. It is particularly preferable that the first anode active material is made of iron.

The anode active material layer can be a layer containing only the anode active material, or it can be a layer containing at least one of an electroconductive material and a binder, in addition to the anode active material. For example, when the anode active material is in a foil form, the anode active material layer can be a layer that contains only the anode active material. On the other hand, when the anode active material is in a powdery form, the anode active material layer can be a layer that contains the anode active material and the binder. The type and content ratio of the binder are as explained above.

The electroconductive material contained in the anode active material layer is not particularly limited, as long as it is electroconductive. The examples include a carbonaceous material, a perovskite-type electroconductive material, a porous electroconductive polymer and a porous metal material. The carbonaceous material can be porous or non-porous. Concrete examples of porous carbonaceous materials include mesoporous carbon. Concrete examples of non-porous carbonaceous materials include graphite, acetylene black, carbon nanotubes and carbon fibers.

The material for the first anode current collector used in the present invention is not particularly limited, as long as it is electroconductive. However, the examples include copper, stainless-steel, nickel and carbon. Of them, SUS and Ni are preferably used as the first anode current collector. As the form of the first anode current collector, there may be mentioned a foil form, a plate form and a mesh (grid) form, for example. In the present invention, the below-described cell case can also function as the first anode current collector.

The first electrolyte layer used in the present invention is retained between the cathode layer and the anode active material layer and functions to exchange metal ions between the layers.

As the first electrolyte layer, there may be used an electrolyte solution, a gel electrolyte, a solid electrolyte, etc. They can be used alone or in combination of two or more kinds.

As the electrolyte solution, there may be used an alkaline electrolyte solution.

As the alkaline electrolyte solution, for example, there may be used a potassium hydroxide aqueous solution, a sodium hydroxide aqueous solution, etc.

The gel electrolyte used in the present invention is generally one gelled by adding a polymer to the alkaline electrolyte solution. For example, it can be obtained by gelling the alkaline electrolyte solution by adding a polymer such as polyethylene oxide (PEO), polyacrylonitrile (PAN) or polymethyl methacrylate (PMMA) to the solution.

As the solid electrolyte, for example, there may be used a sulfide-based solid electrolyte, an oxide-based solid electrolyte, and a polymer electrolyte.

The iron-air assembled cell of the present invention can include a separator between the cathode and anode. As the separator, for example, there may be mentioned porous films of polyolefins such as polyethylene and polypropylene; non-woven fabrics made of resins such as polypropylene, and non-woven fabrics such as a glass fiber non-woven fabric; and a cellulose-based separator.

By impregnating these materials with the above-described alkaline electrolyte solution, these materials can be also used as an alkaline electrolyte solution-supporting material.

In general, the first iron-air unit cell preferably includes a first cell case for housing the first cathode, the first anode, the first electrolyte layer, etc. Concrete examples of the form of the first cell case include a coin form, a flat plate form, a cylindrical form and a laminate form. The cell case can be an open-to-the-atmosphere cell case or a closed cell case. The open-to-the-atmosphere cell case is a cell case that has a structure in which at least the cathode layer can be sufficiently exposed to the atmosphere. On the other hand, when the cell case is a closed cell case, the closed cell case is preferably provided with gas (air) inlet and outlet tubes. In this case, it is preferable that the introduced/emitted gas has a high oxygen concentration, and it is more preferable that the gas is dry air or pure oxygen. Also, it is preferable that the oxygen concentration is high at the time of discharge and low at the time of charge.

Depending on the structure of the cell case, an oxygen permeable membrane and/or a water repellent film can be provided inside the cell case.

Hereinafter, the second iron-air unit cell of the present invention will be described in detail.

The second iron-air unit cell includes at least the second cathode, the second anode and the second electrolyte layer. Of them, the second cathode and the second electrolyte layer are the same as those of the above-described first cathode and first electrolyte layer. Preferably, like the first iron-air unit cell, the second iron-air unit cell includes a second separator and/or a second cell case.

The second anode used in the present invention preferably includes a second anode active material layer containing the second anode active material. In general, it further includes a second anode current collector and an anode lead connected to the second anode current collector.

The second anode used in the present invention contains the second anode active material that contains the iron compound A as a major component. As used herein, “contains the iron compound A as a major component” means that among the amount of the components contained in the second anode active material, the amount of the iron compound A is the highest.

In the present invention, the iron compound A is not particularly limited, as long as it is an oxidized iron compound and allows an air cell using the iron compound A as the anode active material to have a voltage of 0.4 V or more and less than 0.7 V. The iron compound A can be only one kind of iron compound or can be a combination of two or more kinds of iron compounds. As the iron compound A, for example, there may be mentioned Fe(OH)₂ or a combination of Fe(OH)₂ with at least one iron compound selected from the group consisting of FeO, Fe₃O₄, Fe₂O₃, FeOOH and Fe(OH)₃.

It is preferable that the iron compound A contained in the second anode active material accounts for 50% by mass or more of the second anode active material. By containing such a large amount of iron compound A, the anode reactions represented by the formulae (2a) and (2b) proceed in the anode of the second iron-air unit cell; therefore, the second iron-air unit cell has a voltage of 0.4 V or more and less than 0.7 V.

It is more preferable that the iron compound A contained in the second anode active material accounts for 70% by mass or more of the second anode active material. It is still more preferable that the iron compound A contained in the second anode active material accounts for 90% by mass or more of the second anode active material. It is particularly preferable that the second anode active material comprises the iron compound A.

The anode active material layer can be a layer containing only the anode active material, or it can be a layer containing at least one of an electroconductive material and a binder, in addition to the anode active material. For example, when the anode active material is in a foil form, the anode active material layer can be a layer that contains only the anode active material. On the other hand, when the anode active material is in a powdery form, the anode active material layer can be a layer that contains the anode active material and the binder. The type and content ratio of the electroconductive material and the binder are as explained above.

As the second anode current collector, there may be used the same material as the first anode current collector explained above.

In the first embodiment of the iron-air assembled cell according to the present invention, the first iron-air unit cell comprises: (1) a first thin film which contains the first anode active material that contains iron as a major component; (2) a pair of first and second reels to which ends of both extended sides of the first thin film are connected; (3) a first cell case for housing the first thin film and the pair of the first and second reels; (4) the first electrolyte layer arranged in the vicinity of at least part of a path of the first thin film; and (5) the first cathode facing the first thin film through the first electrolyte layer. Also in the first embodiment, the second iron-air unit cell comprises: (1) a second thin film which contains the second anode active material that contains the iron compound A as a major component; (2) a pair of third and fourth reels to which ends of both extended sides of the second thin film are connected; (3) a second cell case for housing the second thin film and the pair of the third and fourth reels; (4) the second electrolyte layer arranged in the vicinity of at least part of a path of the second thin film; and (5) the second cathode facing the second thin film through the second electrolyte layer.

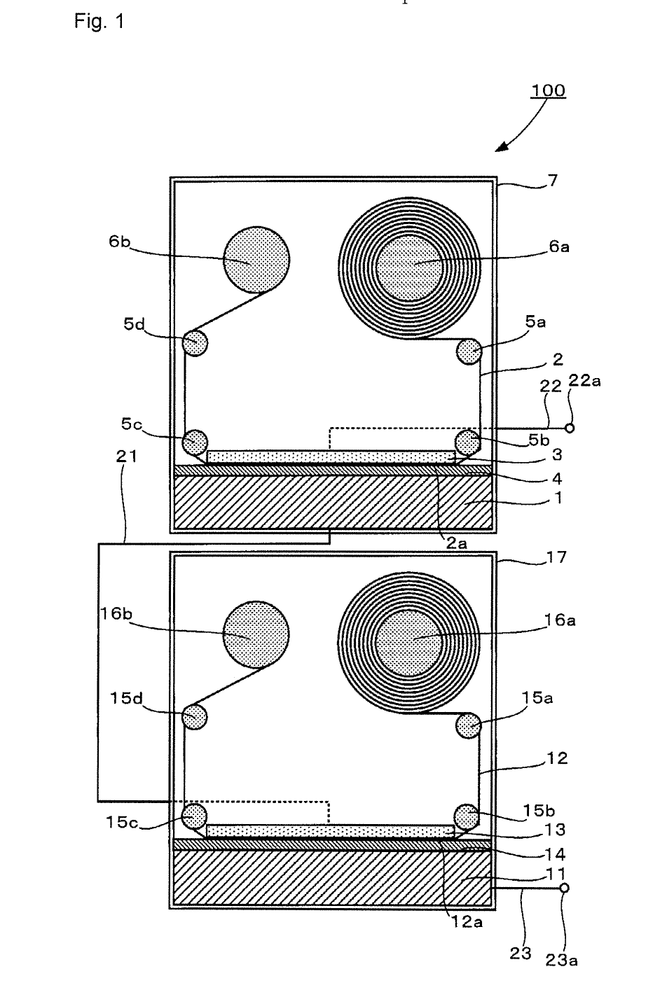

FIG. 1 is a schematic sectional view of a first embodiment of the iron-air assembled cell according to the present invention. For the sake of convenience, some parts of circuits shown in FIG. 1 are indicated by dashed lines.

In a first embodiment 100 of the iron-air assembled cell, the first iron-air unit cell (upper cell shown in FIG. 1) and the second iron-air unit cell (lower cell shown in FIG. 1) are connected in series. The two iron-air unit cells are cartridge-type unit cells.

The first iron-air unit cell includes a first cathode 1, a tape-shaped, iron-containing thin film 2, an anode current collector 3 and a first electrolyte layer 4. A part of the tape-shaped, iron-containing thin film 2 (a part indicated by a heavy line, i.e., 2a) is sandwiched between the anode current collector 3 and the first electrolyte layer 4. That is, from the top of FIG. 1, the anode current collector 3, the part 2a of the anode active material thin film, the first electrolyte layer 4 and the first cathode 1 are stacked in this order. The part 2a of the anode active material thin film functions as the first anode active material of the present invention. The part 2a of the anode active material thin film and the anode current collector 3 function as the first anode of the present invention.

The rest of the tape-shaped, iron-containing thin film 2 is appropriately guided inside the cartridge by guiding members 5a to 5d and then wound by and on a first reel 6a and/or a second reel 6b.

The first iron-air unit cell further includes a first cell case 7 for housing the above-mentioned cell members. As described below, the first cell case 7 can have a cell case hole which allows insertion and removal of the first cathode and the first electrolyte layer.

Since the tape-shaped, iron-containing thin film 2 contains iron (Fe) as a major component, the anode reaction represented by the formula (1) proceeds in the anode of the first iron-air unit cell; therefore, the first iron-air unit cell has a voltage of 0.7 V or more and 1 V or less.

The second iron-air unit cell includes a second cathode 11, a tape-shaped, iron compound A-containing thin film 12, an anode current collector 13 and a second electrolyte layer 14. A part of the tape-shaped, iron compound A-containing thin film 12 (a part indicated by a heavy line, i.e., 12a) is sandwiched between the anode current collector 13 and the second electrolyte layer 14. That is, from the top of FIG. 1, the anode current collector 13, the part 12a of the anode active material thin film, the second electrolyte layer 14 and the second cathode 11 are stacked in this order. The part 12a of the anode active material thin film functions as the second anode active material of the present invention. The part 12a of the anode active material thin film and the anode current collector 13 function as the second anode of the present invention.

Guiding members 15a to 15d, a third reel 16a and a fourth reel 16b are the same as the guiding members 5a to 5d, the first reel 6a and the second reel 6b, respectively.

The second iron-air unit cell has a voltage of 0.4 V or more and less than 0.7 V. The reason will be described below, along with the details of the iron compound A.

The second iron-air unit cell further includes a second cell case 17 for housing the cell members. As described below, the second cell case 17 can have a cell case hole which allows insertion and removal of the second cathode and the second electrolyte layer.

The first cathode 1 of the first iron-air unit cell and the anode current collector 13 of the second iron-air unit cell are connected to each other via a conducting wire 21. A conducting wire 22 extends from the anode current collector 3 of the first iron-air unit cell and has an anode-side terminal 22a at the end thereof. A conducting wire 23 extends from the second cathode 11 of the second iron-air unit cell and has a cathode-side terminal 23a at the end thereof. As just described, the first and second iron-air unit cells are connected in series, so that the potential between the cathode-side terminal 23a and the anode-side terminal 22a is the sum of the voltages of the iron-air unit cells.

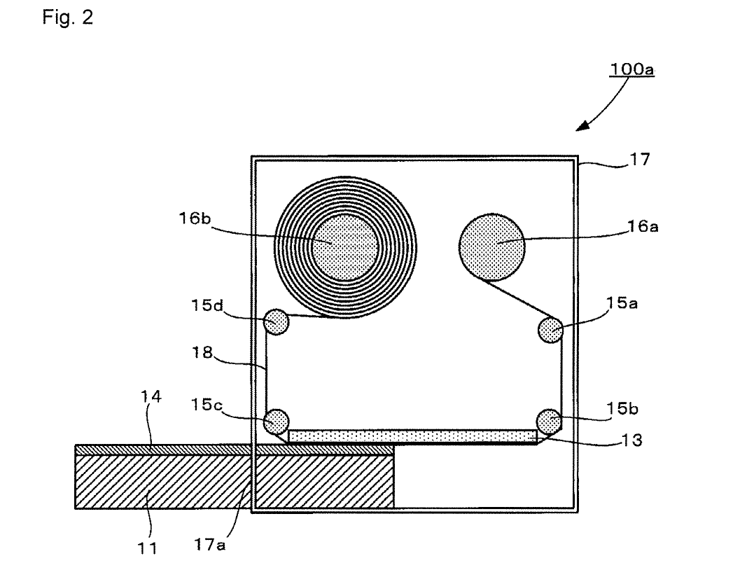

FIG. 2 is a schematic sectional view of the second iron-air unit cell that constitutes the first embodiment, with its second cathode and second electrolyte layer being removed therefrom. In FIG. 2, circuits such as conducting wires as shown in FIG. 1, are omitted.

In FIG. 2, unlike FIG. 1, the thin metal film 18 is guided from the third reel 16a to the fourth reel 16b and then wound by and on the fourth reel 16b. This means that the second iron-air unit cell is now a used iron-air unit cell. In the used second iron-air unit cell 100a, the iron compound A-containing thin film has been oxidized and turned into the used thin metal film 18. FIG. 2 shows a state that such a used thin film is in the process of disposal, together with the cartridge.

The second cell case 17 has an openable and closable cell case hole 17a. The second cathode 11 and the second electrolyte layer 14 are removed through the hole.

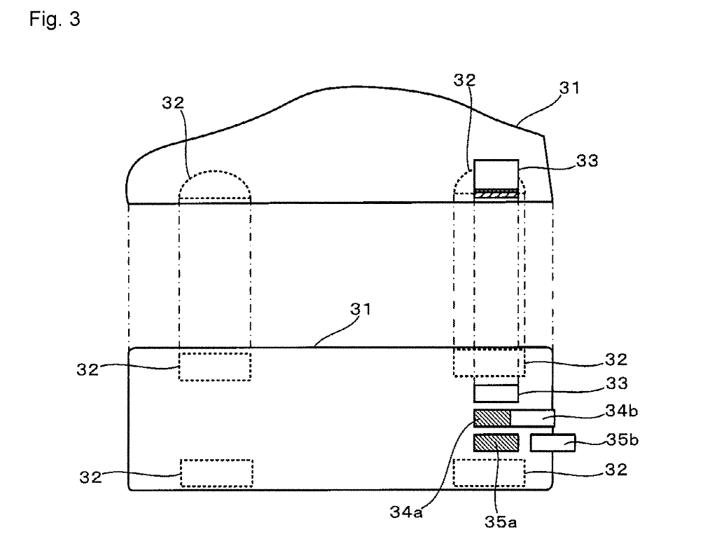

FIG. 3 is a view showing schematically a side face and a top face of a car including the first embodiment of the iron-air assembled cell according to the present invention. An outline 31 schematically shows the outline of a car body. A dashed line 32 schematically shows the position of tires in the car body. The outline 31 and the dashed line 32 serve as mere marks and guide the position of the iron-air assembled cell in a car. That is, the lines do not exactly indicate the position of the iron-air assembled cell. Also in FIG. 3, the car is considered to move in the leftward direction.

In the rear of the car shown in FIG. 3, three bases for installing the iron-air unit cells are provided. The bases allow insertion and removal of the cartridge including the anode, and each base includes a laminate of the cathode and the electrolyte layer, the electrolyte layer being disposed on the cathode. As shown in FIG. 3, an iron-air unit cell 33 is installed in one of the three bases. From a base 34a, which is one of the three bases, a used anode cartridge 34b is being removed. In a base 35a, a new anode cartridge 35b is being installed.

As just described, by appropriately inserting and removing the anode cartridge in and from the base (including the cathode and the electrolyte layer) permanently placed in a car, etc., the used anode can be readily changed to a new anode.

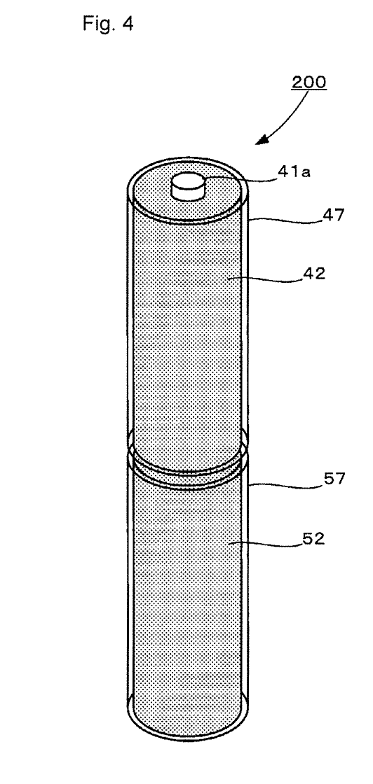

FIG. 4 is a schematic perspective view of a second embodiment of the iron-air assembled cell according to the present invention. In FIGS. 4 to 9, the cell case is drawn as a clear and colorless case. The reason is to show the inside of the cell exactly, so that the cell case is not limited to such a clear and colorless cell case.

In a second embodiment 200 of the iron-air assembled cell, the first iron-air unit cell (upper cell shown in FIG. 4) and the second iron-air unit cell (lower cell shown in FIG. 4) are connected in series. The two iron-air unit cells are cartridge-type unit cells.

The first iron-air unit cell includes a first cathode (not shown), a first anode 42, a first electrolyte layer (not shown) and a first cell case 47. The first anode 42 is in an approximately cylindrical form having a columnar hole in the center and from the top to near the bottom thereof. Also, the first electrolyte layer is disposed inside such an approximately cylindrical first anode 42. The first cathode is located inside the first anode 42. A first cathode terminal 41a is connected to the first cathode. The first cell case 47 houses cell members other than the first cathode terminal 41a.

The second iron-air unit cell includes a second cathode (not shown), a second anode 52, a second electrolyte layer (not shown) and a second cell case 57. The forms of these members are the same as those of the above-mentioned first iron-air unit cell. A second cathode terminal (not shown) connected to an end of the second cathode faces the upper direction in FIG. 4.

In the second embodiment 200, both the bottom face of the first cell case 47 (i.e., the face located on the opposite side of the first cathode terminal 41a) and the bottom face of the second cell case 57 (i.e., the face located on the opposite side of the second cathode terminal) also serve as anode terminals (anode current collectors). Therefore, as shown in FIG. 4, these batteries can be connected in series by bringing the bottom face of the first cell case 47 into contact with the second cathode terminal.

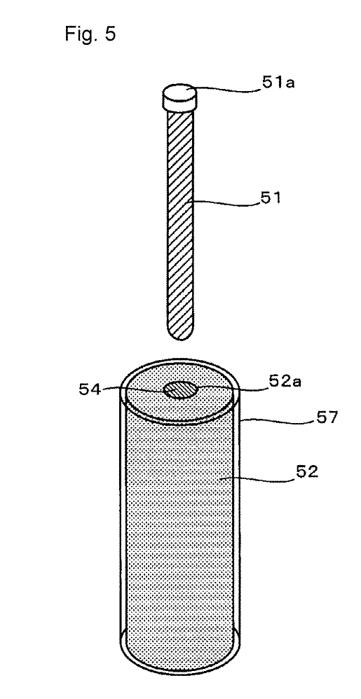

FIG. 5 is a schematic perspective view of the second iron-air unit cell that constitutes the second embodiment, with its second cathode removed therefrom.

As is clear from FIG. 5, a second cathode 51 is in a linear form and has a second cathode terminal 51a at an end thereof. A second electrolyte layer 54 disposed inside the second anode 52 can be seen from a hole 52a left after the removal of the second cathode 51. As just described, the second anode 52, the second electrolyte layer 54 and the second cell case 57 form a cartridge that is removable from the second cathode 51.

After using the second anode 52, the second anode 52 is removed from the assembled cell, together with the second electrolyte layer 54 and the second cell case 57. Then, by inserting the second cathode 51 into the hole of a new cartridge, the assembled cell can discharge power again.

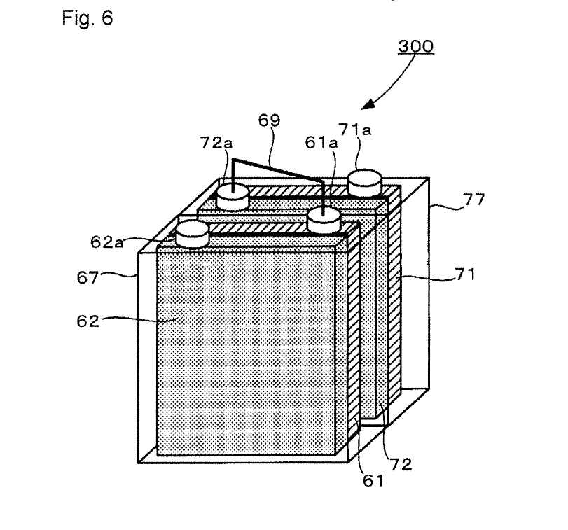

FIG. 6 is a schematic perspective view of a third embodiment of the iron-air assembled cell according to the present invention.

In a third embodiment 300 of the iron-air assembled cell, a first iron-air unit cell (cell on the near side shown in FIG. 6) and a second iron-air unit cell (cell on the far side shown in FIG. 6) are connected in series. The two iron-air unit cells are cartridge-type unit cells.

The first iron-air unit cell includes a first cathode 61, a first anode 62, a first electrolyte layer (not shown) and a first cell case 67. The first cathode 61 is in a sheet form. The first anode 62 is also in a sheet form, and the first electrolyte layer is disposed on the back side of the first anode. A first cathode terminal 61a is disposed on the upper side of the first cathode 61, while a first anode terminal 62a is disposed on the upper side of the first anode 62. The first cell case 67 houses cell members other than the first cathode terminal 61a and the first anode terminal 62a.

The second iron-air unit cell includes a second cathode 71, a second anode 72, a second electrolyte layer (not shown) and a second cell case 77. The forms of these members are the same as those of the first iron-air unit cell.

The first cathode terminal 61a of the first iron-air unit cell and a second anode terminal 72a of the second iron-air unit cell are connected to each other via a conducting wire 69.

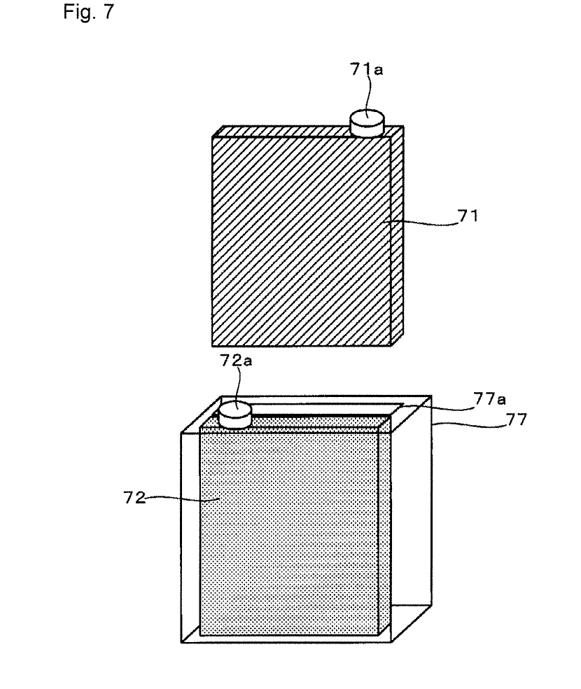

FIG. 7 is a schematic perspective view of the second iron-air unit cell that constitutes the third embodiment, with its cathode removed therefrom.

As is clear from FIG. 7, the second cathode 71 is removable from a second cell case hole 77a. As just described, the second anode 72, a second electrolyte layer (not shown) and the second cell case 77 form a cartridge that is removable from the second cathode 71.

After using the second anode 72, the second anode 72 is removed from the assembled cell, together with the second electrolyte layer and the second cell case 77. Then, by inserting the second cathode 71 into the cell case hole of a new cartridge, the assembled cell can discharge power again.

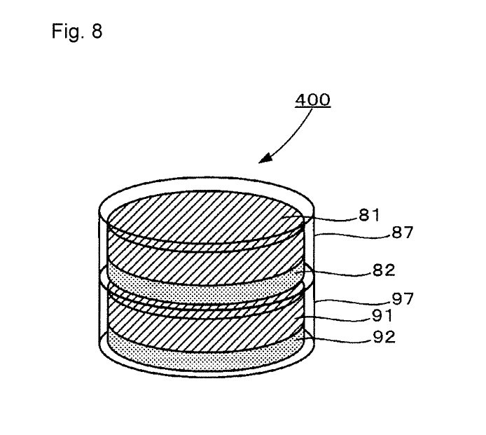

FIG. 8 is a schematic perspective view of a fourth embodiment of the iron-air assembled cell according to the present invention.

In a fourth embodiment 400 of the iron-air assembled cell, the first iron-air unit cell (upper cell shown in FIG. 8) and the second iron-air unit cell (lower cell shown in FIG. 8) are connected in series. The two iron-air unit cells are cartridge-type unit cells.

The first iron-air unit cell includes a first cathode 81, a first anode 82, a first electrolyte layer (not shown) and a first cell case 87. The first cathode 81 is in a disk form. The first anode 82 is also in a disk form, and the first electrolyte layer is disposed on the upper side thereof. The first cell case 87 houses the cell members.

The second iron-air unit cell includes a second cathode 91, a second anode 92, a second electrolyte layer (not shown) and a second cell case 97. The forms of these members are the same as those of the first iron-air unit cell.

In the fourth embodiment 400, the upper and lower sides of the first cell case 87 and those of the second cell case 97 also serve as electrode terminals (current collectors). Therefore, as shown in FIG. 8, the first and second iron-air unit cells can be connected in series by stacking them.

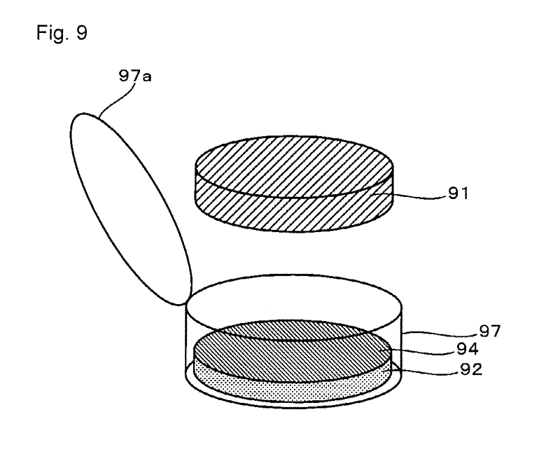

FIG. 9 is a schematic perspective view of the second iron-air unit cell that constitutes the fourth embodiment, with its cathode removed therefrom.

As is clear from FIG. 9, the second cathode 91 can be removed from the second cell case 97 by lifting a lid 97a of the second cell case. By removing the second cathode 91, it is clear that a second electrolyte layer 94 is disposed on the second anode 92. As just described, the second anode 92, the second electrolyte layer 94 and the second cell case 97 form a cartridge that is removable from the second cathode 91.

After using the second anode 92, the second anode 92 is removed from the assembled cell, together with the second electrolyte layer 94 and the second cell case 97. Then, by putting the second cathode 91 in a new cartridge and closing the rid 97a, the assembled cell can discharge power again.

The iron-air assembled cell of the present invention is not limited to the first to fourth embodiments mentioned above. In addition to the first to fourth embodiments in which only the cartridge including the anode is changed, there may be employed an embodiment in which the whole second iron-air unit cell is changed to a new iron-air unit cell (third iron-air unit cell).

### 2. Method for Using the Iron-Air Assembled Cell

The method for using an iron-air assembled cell according to the present invention is a method for using an iron-air assembled cell, the assembled cell comprising: a first iron-air unit cell which comprises at least a first cathode, a first anode comprising a first anode active material that contains iron (Fe) as a major component, and a first electrolyte layer present between the first cathode and anode, and which has a voltage of 0.7 V or more and 1 V or less; and a second iron-air unit cell which comprises at least a second cathode, a second anode comprising a second anode active material that contains an iron compound A as a major component, and a second electrolyte layer present between the second cathode and anode, which has a voltage of 0.4 V or more and less than 0.7 V, and which is connected to the first iron-air unit cell in series, wherein, when the iron (Fe) contained in the first anode is turned into an iron compound A and, as a result, the voltage of the first iron-air unit cell becomes less than 0.7 V, the second anode is changed to a third anode comprising a third anode active material that contains iron (Fe) as a major component, or the second iron-air unit cell is changed to a third iron-air unit cell which comprises at least a third cathode, the third anode, and a third electrolyte layer present between the third cathode and anode, and which has a voltage of 0.7 V or more and 1 V or less.

Inventions discussed in Patent Literature 1 mainly relates to a magnesium-air cell. The magnesium-air cell has just one operating voltage. However, as shown in FIG. 12, an iron-air cell has two operating voltages (0.7 V or more and 1 V or less and 0.4 V or more and 0.6 V or less). Even if the structure of Patent Literature 1 is incorporated in the iron-air cell having two operating voltages, there is a possibility that while in use of the cell, the potential is changed and results in unstable performance. Conventional iron-air cells are needed to keep the voltage of the whole circuits constant by installing therein a transformer in advance, in case there is a change in potential.

The inventor of the present invention has found the following and achieved the present invention: an assembled cell including an iron-air cell that has two operating voltages, can be used efficiently and with no change in potential, without the use of excess devices such as transformer, by using the first iron-air unit cell, which starts discharging at and from a high potential (0.7 V or more and 1 V or less), in combination with the second iron-air unit cell, which starts discharging at and from a low potential (0.4 V or more and less than 0.7 V), and exchanging (1) the second anode for the third anode or (2) the second iron-air unit cell for the third iron-air unit cell when the voltage of the first iron-air unit cell becomes 0.4 V or more and less than 0.7 V.

In the present invention, the time to (1) change the second anode for the third anode is the time when the iron (Fe) contained in the first anode is turned into the iron compound A and, as a result, the voltage of the first iron-air unit cell becomes less than 0.7 V (hereinafter, the time may be referred to as “change time”). The third anode is an anode which contains iron (Fe) as a major component. Details of the third anode are the same as those of the above-mentioned first anode.

As shown in FIG. 12, the time that elapses before the voltage of the iron-air cell having a voltage of near 0.8 V in the beginning of discharging, becomes less than 0.6 V, is shorter than the time that elapses before the voltage of the iron-air cell having a voltage of near 0.6 V in the beginning of discharging, becomes 0 V. Therefore, when the voltage of the first iron-air unit cell becomes less than 0.7 V, the second iron-air unit cell still keeps discharging.

By exchanging the second anode for a new third anode at the change time, the second iron-air unit cell can be used as a cell which starts discharging at and from a high potential (0.7 V or more and 1 V or less), and the first iron-air unit cell can be used as the cell which starts discharging at and from a low potential (0.4 V or more and less than 0.7 V). The two iron-air unit cells are connected in series; therefore, there is no change in the potential of the whole assembled cell before and after the change.

The time at which the voltage of the first iron-air unit cell becomes less than 0.7 V can be found by, for example, monitoring the potential of the first iron-air unit cell with a voltmeter, etc.

In the present invention, the time to (2) change the second iron-air unit cell to the third iron-air unit cell is the change time. The reason is as described above. The third iron-air unit cell means a cell which comprises at least the third cathode, the third anode, and the third electrolyte layer present between the third cathode and anode, and which has a voltage of 0.7 V or more and 1 V or less. Details of the third iron-air unit cell, the third cathode and the third electrolyte layer are the same as those of the first iron-air unit cell, the first cathode and first electrolyte layer.

By exchanging the second iron-air unit cell for a new third iron-air unit cell at the change time, the third iron-air unit cell can be used as a cell which starts discharging at and from a high potential (0.7 V or more and 1 V or less), and the first iron-air unit cell can be used as a cell which starts discharging at and from a low potential (0.4 V or more and less than 0.7 V). The two iron-air unit cells are connected in series; therefore, there is no change in the potential of the whole assembled cell before and after the change.

Due to the above reasons, there is no change in the potential of the assembled cell before and after the change, even in the case of employing the embodiment in which only the anode is changed or in which the whole iron-air unit cell is changed. Therefore, the constant, stable potential supplying effect of the present invention can be received.

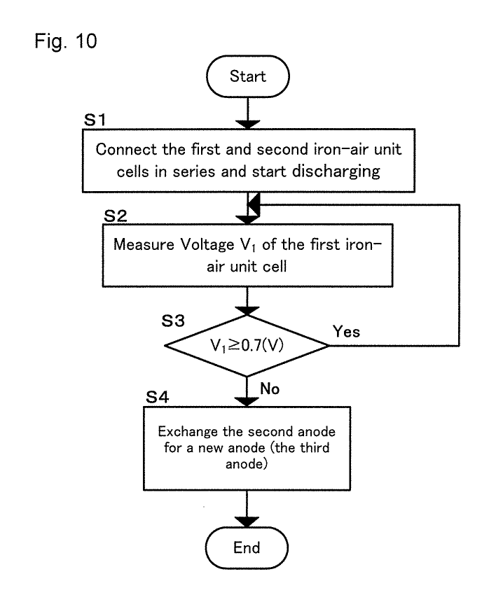

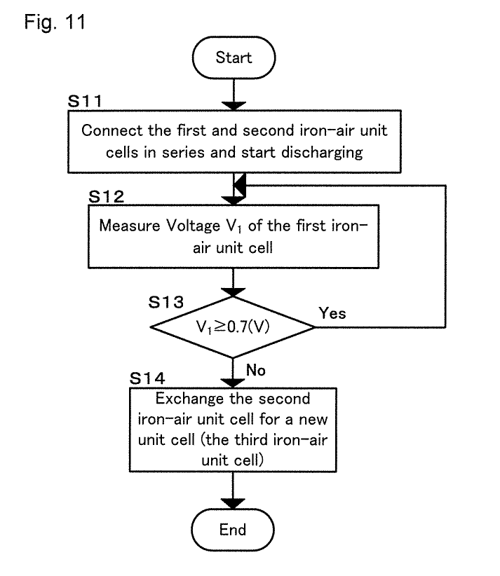

A flowchart of an example of the embodiment in which (1) the second anode is changed to the third anode, is shown in FIG. 10. A flowchart of an example of the embodiment in which (2) the second iron-air unit cell is changed to the third iron-air unit cell, is shown in FIG. 11.

FIG. 10 is a flow chart of a first embodiment of the method for using the iron-air assembled cell according to the present invention. Hereinafter, the case of exchanging the second anode for the third anode will be explained, by reference to the flow shown in FIG. 10. The flow shown in FIG. 10 is applicable to all of the first to fourth embodiments shown in FIGS. 1 to 9.

First, the first and second iron-air unit cells are connected in series and discharging is started (S1). Next, a voltage V₁ of the first iron-air unit cell is measured by a voltage measuring means such as a voltmeter (S2). Then, it is determined whether the measured voltage V₁ is 0.7 (V) or more (S3). When the voltage V₁ is 0.7 (V) or more, the voltage V₁ of the first iron-air unit cell is measured again after the elapse of a certain period of time (S2). On the other hand, when the voltage V₁ is less than 0.7 (V), it is determined that it is the change time. Therefore, the second anode is changed to the third anode, thus ending the change procedure (S4). The flow can be repeated again from S1, considering the used first iron-air unit cell as a new second iron-air unit cell and the second iron-air unit cell subjected to the anode change as a new first iron-air unit cell.

FIG. 11 is a flow chart of a second embodiment of the method for using the iron-air assembled cell according to the present invention. S11 to S13 are the same as S1 to S3 of the first embodiment.

In S13, when the voltage V₁ of the first iron-air unit cell is 0.7 (V) or more, the voltage V₁ is measured again after the elapse of a certain period of time (S12). On the other hand, when the voltage V₁ is less than 0.7 (V), it is determined that it is the change time. Therefore, the second iron-air unit cell is changed to the third iron-air unit cell, thus ending the change procedure (S14). The flow can be repeated again from S11, considering the used first iron-air unit cell as a new second iron-air unit cell and the third iron-air unit cell as a new first iron-air unit cell.

Finally, two applications of the iron-air assembled cell of the present invention will be described.

First, the case of using three iron-air unit cells will be described. The three iron-air unit cells are as follows: (1) an iron-air unit cell A which comprises at least a cathode A, an anode A comprising an anode active material A that contains iron (Fe) as a major component, and an electrolyte layer A present between the cathode A and the anode A, and which has a voltage of 0.8 V or more and 1 V or less; (2) an iron-air unit cell B which comprises at least a cathode B, an anode B comprising an anode active material B that contains iron (Fe) as a major component, and an electrolyte layer B present between the cathode B and the anode B, and which has a voltage of 0.7 V or more and less than 0.8 V; and (3) an iron-air unit cell C which comprises at least a cathode C, an anode C comprising an anode active material C that contains the iron compound A as a major component, and an electrolyte layer C present between the cathode C and the anode C, and which has a voltage of 0.4 V or more and less than 0.7 V. These three iron-air unit cells are connected in series for use. Of them, the iron-air unit cells A and B are the same as the first iron-air unit cell, except voltage. The iron-air unit cell C is the same as the second iron-air unit cell.

In this embodiment, the iron-air unit cell A which starts discharging at and from a high potential (0.8 V or more and 1 V or less), the iron-air unit cell B which starts discharging at and from a middle potential (0.7 V or more and less than 0.8 V), and the iron-air unit cell C which starts discharging at and from a low potential (0.4 V or more and less than 0.7 V), are used in combination. Moreover, like the present invention, a stable potential can be supplied by exchanging an anode C of the iron-air unit cell C for an anode D (anode which is the same in performance as an anode A of the iron-air unit cell A) or exchanging the iron-air unit cell C for an iron-air unit cell D (cell which is the same in performance as the iron-air unit cell A), when the voltage of the iron-air unit cell B becomes less than 0.7 V. As just described, by exchanging one of the three cells, there is such an advantage that the change in potential of the whole assembled cell is smaller than the above-mentioned embodiment in which one of the two cells is changed.

Secondly, applications of the used iron-air unit cell (or the anode or the cartridge thereof) removed from the assembled cell will be described.

Even after removed from the assembled cell, the used iron-air unit cell has a voltage of about 0.2 to 0.4 V and can be used alone as a cell. Applications thereof include a power supply source to a range extender or an electronic device that is operable at low voltage. Especially, in the case of installing the iron-air assembled cell of the present invention in a vehicle, the used iron-air unit cell can be removed from the vehicle and used as an emergency power source at the time of an accident or disaster.

The anode used and removed from the assembled cell and the cartridge thereof can be also used as the electrode device operable at low voltage, by appropriately combining them with the cathode.

### EXAMPLES

Hereinafter, the present invention will be described further in detail, by way of examples. However, the present invention is not limited to the examples.

### 1. Production of Iron-Air Assembled Cell

### Example 1

A cartridge-type iron-air unit cell as shown in FIG. 1 was used as a first iron-air unit cell and also as a second iron-air unit cell. In the first and second iron-air unit cells, a cell reaction is promoted by sandwiching a part of a tape-shaped anode between an anode current collector (SUS304 foil manufactured by Nilaco Corporation) and an electrolyte layer. The rest of the tape-shaped anode is appropriately guided inside the cartridge by guiding members and then wound by and on a first reel and a second reel. By rotating the first and second reels appropriately in the same direction, almost all the tape-shaped anode is involved in a cell reaction.

An anode active material used in the first iron-air unit cell is an iron foil (manufactured by Nilaco Corporation) processed into a tape form. An anode active material used in the second iron-air unit cell is a foil of iron(II) hydroxide (Fe(OH)₂) processed into a tape form.

The cell constituent members which are common to the first and second iron-air unit cells and from which the anode active material is excluded, are as follows.

As an anode electrode current collector, SUS304 foil (manufactured by Nilaco Corporation) was used.

As an electroconductive material, Ketjen Black (“ECP600JD” manufactured by Ketjen Black International) was used. As a binder, PTFE (manufactured by Daikin Industries, Ltd.) was used. These materials were mixed at the following ratio: Ketjen Black:PTFE=90% by mass:10% by mass. Then, the mixture was roll-pressed and dried to produce a cathode layer.

As a cathode current collector, a 100 mesh made of SUS304 (manufactured by Nilaco Corporation) was used.

As a separator, a cellulose-based separator was used. The cellulose-based separator was impregnated with a potassium hydroxide aqueous solution, and the separator impregnated with the solution was used as an electrolyte layer.

Pure oxygen (manufactured by Taiyo Nippon Sanso Corporation, purity 99.9%) was introduced inside the iron-air assembled cell of Example 1.

The voltage of the first and second iron-air unit cells was measured point by point and used to control the rotation speed of the reels.

In particular, in the first iron-air unit cell, a part of the iron foil was kept in contact with the cathode until the voltage of the unit cell decreased to 0.7 V. When the voltage of the unit cell became 0.7 V, the first and second reels were rotated so that the rest of the iron foil was brought into contact with the cathode.

In the second iron-air unit cell, a part of the iron(II) hydroxide foil was kept in contact with the cathode until the voltage of the unit cell decreased to 0.4 V. When the voltage of the unit cell became 0.4 V, the third and fourth reels were rotated so that the rest of the iron(II) hydroxide foil was brought into contact with the cathode.

After the iron foil of the first iron-air unit cell was completely wound on the second reel from the first reel, the second iron-air unit cell was changed to a new iron-air unit cell (third iron-air unit cell) to continue discharging.

### REFERENCE SIGNS LIST

1. First cathode
2. Tape-shaped, iron-containing thin film
2a. Part of the tape-shaped, iron-containing thin film 2 (First anode active material)
3. Negative electrode current collector
4. First electrolyte layer
5a, 5b, 5c, 5d. Guiding member
6a. First reel
6b. Second reel
7. First cell case
11. Second cathode
12. Tape-shaped, iron compound A-containing thin film
12a. Part of the tape-shaped, iron compound A-containing thin film 12 (Second anode active material)
13. Negative electrode current collector
14. Second electrolyte layer
15a, 15b, 15c, 15d. Guiding member
16a. Third reel
16b. Fourth reel
17. Second cell case
17a. Cell case hole
18. Used thin metal film
21, 22, 23. Conducting wire
22a. Negative electrode-side terminal
23a. Positive electrode-side terminal
31. Outline of a car body
32. Dashed line showing the position of tires in the car body
33. Iron-air unit cell
34a, 35a. Base
34b. Used anode cartridge
35b. New anode cartridge
41a. First cathode terminal
42. First anode
47. First cell case
51. Second cathode
51a. Second cathode terminal
52. Second anode
52a. Hole
54. Second electrolyte layer
57. Second cell case
61. First cathode
61a. First cathode terminal
62. First anode
62a. First anode terminal
67. First cell case
69. Conducting wire
71. Second cathode
71a. Second cathode terminal
72. Second anode
72a. Second anode terminal
77. Second cell case
77a. Cell case hole
81. First cathode
82. First anode
87. First cell case
91. Second cathode
92. Second anode
94. Second electrolyte layer
97. Second cell case
97a. Lid of the second cell case
100. First embodiment of the iron-air assembled cell
100a. Used second iron-air unit cell
200. Second embodiment of the iron-air assembled cell
300. Third embodiment of the iron-air assembled cell
400. Fourth embodiment of the iron-air assembled cell

1. A method for using an iron-air assembled cell,
the assembled cell comprising:
a first iron-air unit cell which comprises at least a first cathode, a first anode comprising a first anode active material that contains iron (Fe) as a major component, and a first electrolyte layer present between the first cathode and anode, and which has a voltage of 0.7 V or more and 1 V or less; and
a second iron-air unit cell which comprises at least a second cathode, a second anode comprising a second anode active material that contains an iron compound A as a major component, and a second electrolyte layer present between the second cathode and anode, which has a voltage of 0.4 V or more and less than 0.7 V, and which is connected to the first iron-air unit cell in series,
wherein, when the iron (Fe) contained in the first anode is turned into an iron compound A and, as a result, the voltage of the first iron-air unit cell becomes less than 0.7 V,
the second anode is changed to a third anode comprising a third anode active material that contains iron (Fe) as a major component, or
the second iron-air unit cell is changed to a third iron-air unit cell which comprises at least a third cathode, the third anode, and a third electrolyte layer present between the third cathode and anode, and which has a voltage of 0.7 V or more and 1 V or less.

2. The method for using the iron-air assembled cell according to claim 1,
wherein the first iron-air unit cell comprises:
a first thin film which contains the first anode active material that contains iron as a major component;
a pair of first and second reels to which ends of both extended sides of the first thin film are connected;
a first cell case for housing the first thin film and the pair of the first and second reels;
the first electrolyte layer arranged in the vicinity of at least part of a path of the first thin film; and
the first cathode facing the first thin film through the first electrolyte layer, and
wherein the second iron-air unit cell comprises:
a second thin film which contains the second anode active material that contains the iron compound A as a major component;
a pair of third and fourth reels to which ends of both extended sides of the second thin film are connected;
a second cell case for housing the second thin film and the pair of the third and fourth reels;
the second electrolyte layer arranged in the vicinity of at least part of a path of the second thin film; and
the second cathode facing the second thin film through the second electrolyte layer.

3. The method for using the iron-air assembled cell according to claim 1,
wherein the iron contained in the first anode active material accounts for 50% by mass or more of the first anode active material.

4. The method for using the iron-air assembled cell according to claim 1,
wherein the iron compound A contained in the second anode active material accounts for 50% by mass or more of the second anode active material.

5. An iron-air assembled cell,
wherein the assembled cell comprises:
a first iron-air unit cell which comprises at least a first cathode, a first anode comprising a first anode active material that contains iron (Fe) as a major component, and a first electrolyte layer present between the first cathode and anode, and which has a voltage of 0.7 V or more and 1 V or less; and
a second iron-air unit cell which comprises at least a second cathode, a second anode comprising a second anode active material that contains an iron compound A as a major component, and a second electrolyte layer present between the second cathode and anode, which has a voltage of 0.4 V or more and less than 0.7 V, and which is connected to the first iron-air unit cell in series.

6. The iron-air assembled cell according to claim 5,
wherein the first iron-air unit cell comprises:
a first thin film which contains the first anode active material that contains iron as a major component;
a pair of first and second reels to which ends of both extended sides of the first thin film are connected;
a first cell case for housing the first thin film and the pair of the first and second reels;
the first electrolyte layer arranged in the vicinity of at least part of a path of the first thin film; and
the first cathode facing the first thin film through the first electrolyte layer, and
wherein the second iron-air unit cell comprises:
a second thin film which contains the second anode active material that contains the iron compound A as a major component;
a pair of third and fourth reels to which ends of both extended sides of the second thin film are connected;
a second cell case for housing the second thin film and the pair of the third and fourth reels;
the second electrolyte layer arranged in the vicinity of at least part of a path of the second thin film; and
the second cathode facing the second thin film through the second electrolyte layer.

7. The iron-air assembled cell according to claim 5,
wherein the iron contained in the first anode active material accounts for 50% by mass or more of the first anode active material.

8. The iron-air assembled cell according to claim 5,
wherein the iron compound A contained in the second anode active material accounts for 50% by mass or more of the second anode active material.
